(19) United States
(12) Patent Application Publication
(10) Pub. No.: US 2018/0207752 A1
(43) Pub. Date: Jul. 26, 2018

(54) CARRYING TABLE AND CUTTING METHOD

(71) Applicant: BOE TECHNOLOGY GROUP CO., LTD., Beijing (CN)

(72) Inventors: Xiaohu LI, Beijing (CN); Zhongyuan SUN, Beijing (CN); Lu WANG, Beijing (CN); Haibin ZHU, Beijing (CN)

(73) Assignee: BOE TECHNOLOGY GROUP CO., LTD., Beijing (CN)

(21) Appl. No.: 15/541,858

(22) PCT Filed: Jan. 3, 2017
(86) PCT No.: PCT/CN2017/000035

§ 371 Date: Jul. 6, 2017

(30) Foreign Application Priority Data
May 17, 2016 (CN) 201610326162.3

(51) Int. Cl. B23K 26/38; B23K 26/70; B23K 37/04

(52) U.S. Cl. CPC B23K 26/38; B23K 37/0408; B23K 26/70

(57) ABSTRACT

A carrying table and a cutting method are disclosed. The carrying table includes: a carrying table body including a carrying table surface provided with a plurality of openings; and a plurality of pistons respectively disposed in at least part of openings and configured to conduct reciprocating movement relative to the carrying table surface along side walls of the openings. The carrying table and the cutting method can reduce or eliminate the local deformation of a membrane object to be cut during cutting in the use process, and reduce or avoid the poor processes such as widened cutting line and reduced cutting precision in the cutting process.

### TECHNICAL FIELD

Embodiments of the present disclosure relate to a carrying table and a cutting method.

### BACKGROUND

In industrial production, often it is necessary to cut an object to be cut, and it is necessary to use a carrying table for carrying the object to be cut during the operation of cutting.

Laser cutting is a cutting process by utilization of laser generated by material excitation. When the laser contacts the object to be cut, the object to be cut can be quickly melted, and the cutting process can be completed by laser movement along a default path. Compared with the traditional cutting method, laser cutting has the advantages such as higher cutting precision, smaller gap, and capability of saving material, and hence has been more and more widely applied to industrial production.

### SUMMARY

An embodiment of the present disclosure provides a carrying table, comprising: a carrying table body including a carrying table surface provided with a plurality of openings; and a plurality of pistons respectively disposed in at least part of openings and configured to conduct reciprocating movement relative to the carrying table surface along side walls of the openings.

For example, the carrying table according to an embodiment of the present disclosure further comprises a drive mechanism, wherein the drive mechanism is configured to respectively drive the plurality of pistons to conduct reciprocating movement relative to the carrying table surface along the side walls of the openings.

For example, the carrying table according to an embodiment of the present disclosure, the drive mechanism includes a connecting portion and a transmission portion connected with the connecting portion; and the pistons and the transmission portion are connected with each other through the connecting portion.

For example, the carrying table according to an embodiment of the present disclosure further comprises a power unit, wherein the power unit is connected with the transmission portion and can drive the transmission portion.

For example, the carrying table according to an embodiment of the present disclosure, the power unit includes one or a combination of an electric motor, a fuel engine and a manual power unit.

For example, the carrying table according to an embodiment of the present disclosure, the piston is made from an elastic material.

For example, the carrying table according to an embodiment of the present disclosure, the pistons and the side walls of the openings fit tightly.

For example, the carrying table according to an embodiment of the present disclosure, the plurality of openings have a same dimension.

For example, the carrying table according to an embodiment of the present disclosure, the plurality of openings are distributed in a matrix.

For example, the carrying table according to an embodiment of the present disclosure further comprises an air pressure sensor, wherein the air pressure sensor is disposed on the side wall of at least one opening and at a position between one piston and the carrying table surface or on one side of the one piston close to the carrying table surface.

For example, the carrying table according to an embodiment of the present disclosure further comprises a controller, wherein the controller is configured to receive actual air pressure data detected and sent by the air pressure sensor, compare the actual air pressure data with default air pressure data, and hence control the movement direction of the piston.

For example, the carrying table according to an embodiment of the present disclosure further comprises an input unit and an output unit, wherein the input unit is configured to input the default air pressure data and the output unit is configured to output the actual air pressure data.

An embodiment of the present disclosure provides a membrane cutting method employing the carrying table according to any embodiment, comprising: arranging the membrane object to be cut on the carrying table surface of the carrying table body, in which the object to be cut at least covers part of the openings; driving the pistons to move towards the direction away from the carrying table surface along the side walls of the openings, so as to adsorb the membrane object to be cut on the carrying table surface; and cutting the object to be cut.

For example, the carrying table according to an embodiment of the present disclosure further comprises: driving the pistons to move towards the direction close to the carrying table surface along the side walls of the openings for initialization, before the step of arranging the object to be cut on the carrying table surface.

For example, the carrying table according to an embodiment of the present disclosure, in the process of cutting the object to be cut, the cutting path runs through part of the openings covered by the object to be cut.

For example, the carrying table according to an embodiment of the present disclosure further comprises: driving the piston to move towards the direction close to the carrying table surface along the side wall of the opening when the actual air pressure data in the opening is less than the default air pressure data; and driving the piston to move towards the direction away from the carrying table surface along the side wall of the opening when the actual air pressure data in the opening is greater than the default air pressure data.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic side view 1 of a carrying table provided by the embodiment of the present disclosure;

FIG. 2 is a schematic side view 2 of the carrying table provided by the embodiment of the present disclosure;

FIG. 3 is a schematic top view of the carrying table provided by the embodiment of the present disclosure; and

FIG. 4 is a flow diagram of a cutting method provided by the embodiment of the present disclosure.

### REFERENCE NUMERALS

10—carrying table; 100—carrying table body; 110—carrying table surface; 120—opening; 130—piston; 200—drive mechanism; 210—connecting portion; 220—transmission portion; 300—power unit; 400—air pressure sensor; 500—controller; 600—input unit; 700—output unit; 800—membrane object to be cut.

### DETAILED DESCRIPTION

Clear and complete description will be given below to the technical proposals of the embodiments of the present disclosure in combination with the accompanying drawings. More comprehensive description will be given to the preferred embodiments of the present disclosure and various features and favorable details thereof with reference to non-limiting preferred embodiments illustrated in the accompanying drawings and described in detail in the following description. It should be noted that the characteristics illustrated in the figures are not necessary to be drawn in proportion. The description on the known materials, components and processes has been omitted in the present disclosure for clear description of the preferred embodiments of the present disclosure. The given examples are only construed for the understanding of the implementation of the preferred embodiments of the present disclosure, so that the examples can be implemented by those skilled in the art. Therefore, the examples shall not be construed as the limitation of the scope of the embodiments of the present disclosure.

Unless otherwise specified, the technical terms or scientific terms used in the present disclosure shall have normal meaning understood by those skilled in the art. In addition, in the embodiments of the present disclosure, same or similar reference numerals indicate same or similar members.

In the process of, for example, manufacturing a flexible display panel, a flexible membrane object to be cut must be cut. In the process of, for example, laser cutting, the membrane object to be cut can be fixed on a carrying table by means of negative pressure adsorption, but the membrane object to be cut can be easily deformed in the case of negative pressure adsorption. Thus, poor processes such as widened cutting line or reduced cutting precision can be caused in the cutting process.

The carrying table and the cutting method provided by the embodiments of the present disclosure can reduce or eliminate the local deformation of the membrane object to be cut during cutting, and reduce or avoid the poor processes such as widened cutting line or reduced cutting precision in the cutting process.

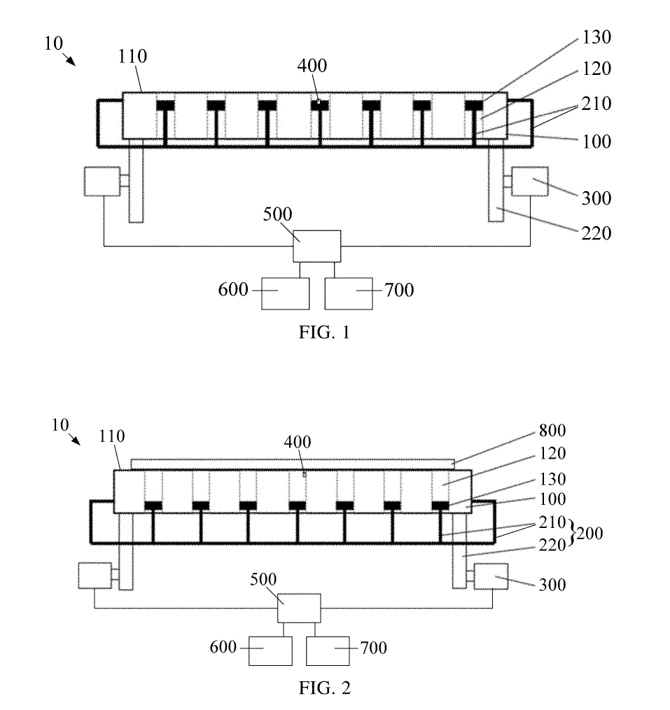

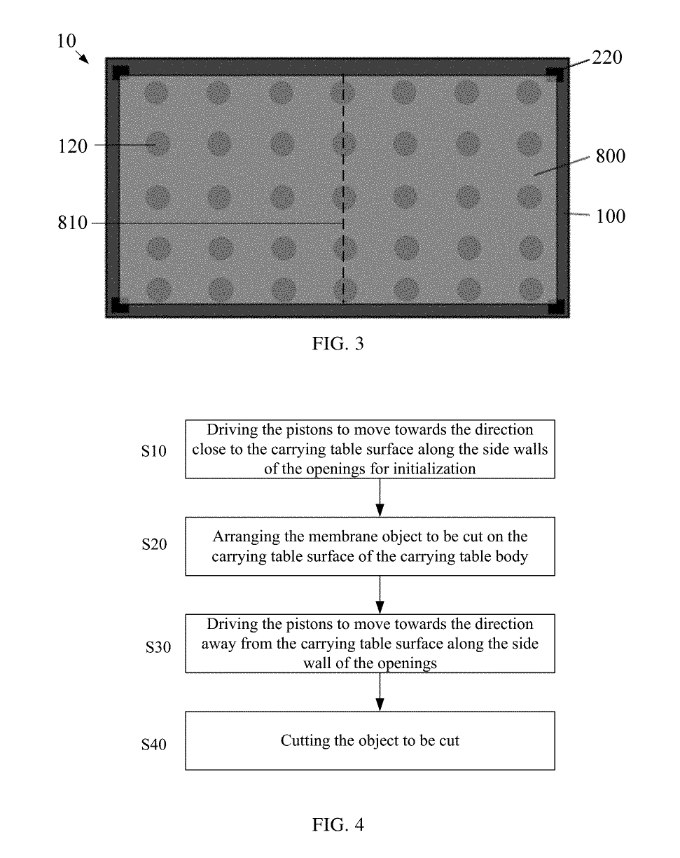

FIG. 1 is a schematic side view 1 of a carrying table provided by an embodiment of the present disclosure; FIG. 2 is a schematic side view 2 of the carrying table provided by an embodiment of the present disclosure; and FIG. 3 is a schematic top view of the carrying table provided by an embodiment of the present disclosure.

As illustrated in FIGS. 1 to 3, the embodiment of the present disclosure provides a carrying table 10, which comprises a carrying table body 100 and a plurality of pistons 130. The carrying table body 100 includes a carrying table surface 110. The carrying table surface 110 is provided with a plurality of openings 120. The plurality of pistons 130 are respectively disposed in at least part of openings 120 and configured to conduct reciprocating movement relative to the carrying table surface 110 along side walls of the openings 120. Thus, when an opening of the opening on the carrying table surface 110 is covered by a film (an example of the membrane object to be cut), the air pressure in the opening 120 may be correspondingly adjusted.

For example, the carrying table 10 may be made of a high temperature resistant inorganic material such as aluminum or other metal or marble, so that the carrying table 10 can withstand high temperature generated by, for example, laser cutting.

For example, each opening 120 is provided with the piston 130 therein.

For example, each opening 120 runs through the carrying table body 100.

For example, the carrying table 10 provided by an embodiment of the present disclosure further comprises a drive mechanism 200. The drive mechanism 200 is configured to respectively drive the plurality of pistons 130 to conduct reciprocating movement relative to the carrying table surface 110 along the side walls of the openings 120.

For example, the drive mechanism 200 may also be configured to drive the carrying table body 100 to conduct reciprocating movement relative to the pistons 130.

For example, in the carrying table 10 provided by an embodiment of the present disclosure, the drive mechanism 200 includes a connecting portion 210 and a transmission portion 220 connected with the connecting portion 210; and the pistons 130 are connected with the transmission portion 220 through the connecting portion 210 and then can be driven by the transmission portion 220.

For example, the connecting portion 210 and the transmission portion 220 are connected with each other through a threaded structure or a gear structure. The transmission portion 220 is, for example, a transmission shaft.

For example, the carrying table 10 provided by an embodiment of the present disclosure may further comprise a power unit 300. The power unit 300 can be connected with the transmission portion 220 in the working process and hence can drive the transmission portion 220.

For example, the transmission portion 220 and the power unit 300 are connected with each other through a threaded structure or a gear structure, so that the power unit 300 can drive the transmission portion 220.

For example, in the carrying table 10 provided by an embodiment of the present disclosure, the power unit 300 includes one or a combination of an electric motor, a fuel engine and a manual power unit. The electric motor is, for example, a stepper motor. The rotation angle, the rotation speed and the rotation direction of the stepper motor may be adjusted by adjusting pulse signals applied to the stepper motor.

For example, the power unit 300 can drive the transmission portion 220 to move; the transmission portion 220 can drive the connecting portion 210 to move; and then the connecting portion 210 can drive the pistons 130 to move.

For example, the movement direction of the transmission portion 220 and the connecting portion 210 may be changed by changing the movement direction of the power unit 300 (for example, the rotation direction of the electric motor), so that the movement direction of the piston 130 can be changed, and hence the piston 130 can be driven to conduct reciprocating movement relative to the carrying table surface 110 along the side wall of the opening 120.

For example, as illustrated in FIGS. 1 and 2, the pistons 130 are combined into a whole through the connecting portion 210 and move synchronously under the driving of the power unit 300 and the transmission portion 220. That is to say, at the same moment, all the pistons 130 are disposed at same positions in the openings 120 and can synchronously move towards the direction close to or away from the carrying table surface 110 along the side walls of the openings 120.

It should be noted that the embodiment of the present disclosure includes but not limited to the case that the pistons 130 are combined into a whole through the connecting portion 210. Each piston 130 may also be driven by a set of independent drive mechanisms and power units, namely each piston 130 is respectively driven by a set of connecting portion, transmission portion, and power unit corresponding to the piston, so that the respective movement of each piston 130 can be realized. The air pressure of the opening provided with the piston 130 may be more accurately controlled in the working process by flexible adjustment of the position of each piston 130.

For example, the piston 130 is a solid piston. The solid piston refers to that there is no communication hole or air flue between a surface of the piston 130 close to the carrying table surface 110 and a surface of the piston 130 away from the carrying table surface 110, so as to ensure the tightness of the piston 130.

For example, in the carrying table 10 provided by an embodiment of the present disclosure, the piston 130 may be made of an elastic material. For example, the piston 130 made of the elastic material can better ensure the tightness between the piston 130 and the side wall of the opening 120.

For example, in the carrying table 10 provided by an embodiment of the present disclosure, the piston 130 and the side wall of the corresponding opening 120 fit tightly.

For example, the case that the piston 130 and the side wall of the opening 120 fit tightly indicates that there is no air leakage or basically no air leakage between the piston 130 and the side wall of the opening 120, so as to ensure that a membrane object to be cut 800, the side wall of the opening 120 and the piston 130 can be combined into a closed cavity when the membrane object to be cut 800 is disposed on the carrying table surface 110. Thus, the air pressure of the cavity can be changed when the piston 130 moves along the side wall of the opening 120.

For example, in the carrying table 10 provided by an embodiment of the present disclosure, the plurality of openings 120 have a same dimension, and sections of the openings, for example, may be all circular, elliptical, rectangular, etc.

For example, in the carrying table 10 provided by an embodiment of the present disclosure, the plurality of openings 120 are distributed in a matrix/array and may be distributed on almost the entire surface or partial surface.

For example, the piston 130 may be set to be detachable to provide convenience for the maintenance and replacement of the piston 130. For example, the pistons 130 may be flexibly disposed in the openings 120 according to the dimension of the membrane object to be cut and the cutting path, and the number of the pistons 130 can be reduced when the membrane object to be cut has a small dimension.

For example, the opening 120 is cylindrical. For example, the cylindrical opening 120 provides convenience for the assembly and disassembly of the piston 130.

For example, the carrying table 10 provided by an embodiment of the present disclosure further comprises an air pressure sensor 400. The air pressure sensor 400 is disposed in at least one opening 120, For example, disposed on the side wall of the opening 120 and at a position between the piston 130 and the carrying table surface 110 or on one side of the piston 130 close to the carrying table surface.

For example, as illustrated in FIG. 1, the air pressure sensor 400 is disposed on one side of the piston 130 close to the carrying table surface 110. For example, as illustrated in FIG. 2, the air pressure sensor 400 is disposed on the side wall of the opening 120 and at a position between the piston 130 and the carrying table surface 110. Moreover, for example, the air pressure sensor 400 is disposed on the side wall of the opening 120 and at a position between the carrying table surface 110 and a position, closest to the carrying table surface 110, where the piston 130 can arrive at during reciprocating movement. The air pressure sensor 400 with the setting can measure the actual air pressure in the cavity combined by the membrane object to be cut 800, the side wall of the opening 120 and the piston 130 in the working process.

It should be noted that the embodiments of the present disclosure includes but not limited to the case as illustrated in FIG. 1 or 2, and the air pressure sensor 400 may also be disposed on each piston 130 or the side wall of each opening 120, so as to acquire the air pressure in each closed cavity, and accurately control the air pressure in each closed cavity in combination with the independent driving means of each piston 130 described above and a controller 500 described below. Thus, the membrane object to be cut can be uniformly adsorbed on the carrying table surface 110 of the carrying table 100, and hence the deformation of the membrane object to be cut 800 can be reduced.

For example, the carrying table 10 provided by an embodiment of the present disclosure may further comprise a controller 500. The controller 500 is, for example, in signal connection with the air pressure sensor 400, the drive mechanism 200, the power unit 300 or the like by wired or wireless means. The air pressure sensor 400 may send actual air pressure data measured in real time in the working process to the controller 500. The controller 500 is configured to receive the actual air pressure data sent by the air pressure sensor 400, compare the actual air pressure data with default air pressure data (or referred to as reference air pressure data), and hence control the movement direction of the piston 130.

For example, the default air pressure data include history data stored in the controller 500 or manually inputted data.

For example, the air pressure sensor 400 and the controller 500 transmit data by wireless communication (e.g., Bluetooth or WLAN) or wired communication.

For example, the controller 500 and the power unit 300 transmit data by wireless communication (e.g., Bluetooth or WLAN) or wired communication.

For example, in the cutting process, when the actual air pressure data is less than the default air pressure data, the controller 500 sends a pressure boost signal to the power unit 300, and the power unit 300 drives the drive mechanism 200 to drive the piston 130 to move towards the direction close to the carrying table surface 110 along the side wall of the opening 120, so as to increase the air pressure in the closed cavity; and when the actual air pressure data in the closed cavity is greater than the default air pressure data, the controller 500 sends a pressure reduction signal to the power unit 300, and the power unit 300 drives the drive mechanism 200 to drive the piston 130 to move towards the direction away from the carrying table surface 110 along the side wall of the opening 120, so as to reduce the air pressure in the closed cavity.

For example, the controller 500 may be implemented by a signal processor such as a field-programmable gate array (FPGA), a digital signal processor (DSP) or a microcontroller.

For example, the controller 500 may include a processor and a memory. The processor executes software programs stored in the memory and achieves the functions of comparing the actual air pressure data with the default air pressure data and sending a pressure boost signal or a pressure reduction signal to the power unit 300, and then controls the movement direction of the piston 130.

For example, the carrying table 10 provided by the embodiment of the present disclosure may further comprise an input unit 600 and an output unit 700. The input unit 600 is configured to input the default air pressure data, and the output unit 700 is configured to output the actual air pressure data.

For example, the input unit 600 may be a touch panel, a keyboard, a mouse, etc. For example, the output unit 700 may be a display, a signal lamp, a printer, a sound or vibration alarm unit, etc.

For example, the input unit 600 and the controller 500 transmit data by wireless communication (e.g., Bluetooth or WLAN) or wired communication.

For example, the output unit 700 and the controller 500 transmit data by wireless communication (e.g., Bluetooth or WLAN) or wired communication.

For example, the input unit 600 may provide convenience for an operator to flexibly input the default air pressure data according to the conditions of different membrane objects to be cut (for example, the material, size, shape and the like of the membrane object to be cut).

For example, the output unit 700 may output the default air pressure data, the actual air pressure data and the difference between the default air pressure data and the actual air pressure data, so that the operator can intuitively understand the working conditions of carrying table 10.

For example, the working process of the carrying table 10 will be illustratively given below.

As illustrated in FIG. 1, before the membrane object to be cut 800 (e.g., a flexible substrate) is disposed on the carrying table surface 110 of the carrying table 10, the controller 500 sends an initialization signal to the power unit 300 in a wired or wireless communication way; in response to the initialization signal, the power unit 300 drives the transmission portion 220 to move, and the transmission portion 220 drives the connecting portion 210 to move, so that the piston 130 can be driven to move towards the direction close to the carrying table surface 110 along the side wall of the opening 120 and stop at an initialization position close to the carrying table surface 110. The initialization position is, for example, a position where the piston 130 is the closest to the carrying table surface 110 during the reciprocating movement in the opening 120. At this point, the air pressure in the opening 120 is the same as the ambient pressure (e.g., 1 atmospheric pressure (atm)).

As illustrated in FIG. 2, the membrane object to be cut 800 is laid on the carrying table surface 110 of the carrying table 10 and hence covers the opening of the opening 120 in the surface, and the membrane object to be cut 800, the side wall of the opening 120 and the piston 130 are combined to provide a closed cavity. The operator determines the default air pressure according to the material, size and shape information of the membrane object to be cut 800, and inputs the default air pressure (the default air pressure is, For example, less than the ambient pressure) through the input unit 600, and the input unit 600 sends the default air pressure data to the controller 500. The air pressure sensor 400 measures the actual air pressure data in the closed cavity at this point, and sends the actual air pressure data to the controller 500 by wired or wireless communication; the controller 500 compares the default air pressure data with the actual air pressure data, determines whether the actual air pressure data is greater than the default air pressure data, and sends a pressure reduction signal to the power unit 300; and the power unit 300 drives the drive mechanism 200 to drive the piston 130 to move towards the direction away from the carrying table surface 110 along the side wall of the opening 120, so as to reduce the air pressure in the closed cavity and adsorb the membrane object to be on the carrying table surface 110. For example, during the movement of the piston 130, the air pressure sensor 400 sends the actual air pressure data to the controller 500 in real time; the controller 500 sends the default air pressure data and the actual air pressure data to the output unit 700 in real time; and the output unit 700 outputs the default air pressure data and the actual air pressure data in real time. When the actual air pressure data in the closed cavity is less than the default air pressure data, the controller 500 sends a pressure boost signal to the power unit 300, and the power unit 300 drives the drive mechanism 200 to drive the piston 130 to move towards the direction close to the carrying table surface 110 along the side wall of the opening 120, so as to increase the air pressure in the closed cavity. The closed-loop control of the actual air pressure in the closed cavity is realized by the cycle of pressure reduction and pressure boost, until the actual air pressure is equal to the default air pressure. At this point, the controller 500 sends an air pressure adjustment completion signal to the power unit, and the power unit 300 stops moving in response to the air pressure adjustment completion signal.

As illustrated in FIG. 3, the membrane object to be cut 800 is cut along a cutting line 810, and in the entire cutting process, the power unit 300 does not move again, so that the piston 130 can maintain the resting state. For example, the cutting line 810 runs through part of through holes 120 covered by the membrane object to be cut 800; when the edge of certain through hole 120 is cut, as the membrane object to be cut 800 is penetrated so that the closed cavity corresponding to the through hole 120 is in communication with the ambient pressure, the membrane object to be cut 800 near the through hole 120 is in the natural extending state. Thus, the local deformation caused by adsorption can be reduced or eliminated, and hence the poor processes such as widened cutting line and reduced cutting precision can be avoided.

FIG. 4 is a flow diagram of a cutting method provided by the embodiment of the present disclosure. As illustrated in FIG. 4, the embodiment of the present disclosure further provides a membrane cutting method employing the carrying table provided by any embodiment of the present disclosure, which comprises the following operations:

S10: driving the pistons to move towards the direction close to the carrying table surface along the side walls of the openings for initialization;

S20: arranging the membrane object to be cut on the carrying table surface of the carrying table body, in which the object to be cut at least covers part of the openings;

S30: driving the pistons to move towards the direction away from the carrying table surface along the side walls of the openings, so as to adsorb the membrane object to be cut on the carrying table surface; and

S40: cutting the object to be cut.

For example, step S10 may also be completed after the end of each cutting process. For example, step S10 may also be omitted when the piston is at a position close to the carrying table surface and the movement of the piston is enough for the actual air pressure in the closed cavity to be equal to the default air pressure.

For example, in the cutting method provided by an embodiment of the present disclosure, in the process of cutting the object to be cut, the cutting path runs through part of the openings covered by the object to be cut.

For example, the cutting method provided by an embodiment of the present disclosure may further comprise: when the actual air pressure data is less than the default air pressure data, the piston is driven to move towards the direction close to the carrying table surface along the side wall of the opening; and when the actual air pressure data is greater than the default air pressure data, the piston is driven to move towards the direction away from the carrying table surface along the side wall of the opening.

The carrying table and the cutting method provided by the embodiments of the present disclosure can reduce or eliminate the local deformation of the membrane object to be cut in the cutting process, and reduce or avoid the poor processes such as widened cutting line and reduced cutting precision in the cutting process.

It is apparent to those skilled in the art that although detailed description has been given above to the present disclosure with reference to the general description and the preferred embodiments, some modifications and improvements may be made on the basis of the embodiments of the present disclosure. Therefore, the modifications or improvements made without departing from the spirit of the present disclosure shall fall within the scope of protection of the present disclosure.

The application claims priority to the Chinese patent application No. 201610326162.3, filed May 17, 2016, the entire disclosure of which is incorporated herein by reference as part of the present application.

1. A carrying table, comprising:
a carrying table body including a carrying table surface provided with a plurality of openings; and
a plurality of pistons respectively disposed in at least part of openings and configured to conduct reciprocating movement relative to the carrying table surface along side walls of the openings.

2. The carrying table according to claim 1, further comprising a drive mechanism, wherein the drive mechanism is configured to respectively drive the plurality of pistons to conduct reciprocating movement relative to the carrying table surface along the side walls of the openings.

3. The carrying table according to claim 2, wherein the drive mechanism includes a connecting portion and a transmission portion connected with the connecting portion; and
the pistons and the transmission portion are connected with each other through the connecting portion.

4. The carrying table according to claim 3, further comprising a power unit, wherein the power unit is connected with the transmission portion and can drive the transmission portion.

5. The carrying table according to claim 4, wherein the power unit includes one or a combination of an electric motor, a fuel engine and a manual power unit.

6. The carrying table according to claim 1, wherein the piston is made from an elastic material.

7. The carrying table according to claim 1, wherein the pistons and the side walls of the openings fit tightly.

8. The carrying table according to claim 1, wherein the plurality of openings have a same dimension.

9. The carrying table according to claim 1, wherein the plurality of openings are distributed in a matrix.

10. The carrying table according to claim 1, further comprising an air pressure sensor, wherein the air pressure sensor is disposed on a side wall of at least one opening and at a position between one piston and the carrying table surface or on one side of the one piston close to the carrying table surface.

11. The carrying table according to claim 10, further comprising a controller,
wherein the controller is configured to receive actual air pressure data detected and sent by the air pressure sensor, compare actual air pressure data with default air pressure data, and hence control a movement direction of the piston.

12. The carrying table according to claim 11, further comprising an input unit and an output unit, wherein
the input unit is configured to input the default air pressure data; and
the output unit is configured to output the actual air pressure data.

13. A membrane cutting method employing the carrying table according to claim 1, comprising:
arranging the membrane object to be cut on the carrying table surface of the carrying table body, in which the object to be cut at least covers part of the openings;
driving the pistons to move towards a direction away from the carrying table surface along the side walls of the openings, so as to adsorb the membrane object to be cut on the carrying table surface; and
cutting the object to be cut.

14. The cutting method according to claim 13, further comprising:
driving the pistons to move towards a direction close to the carrying table surface along the side walls of the openings for initialization, before arranging the object to be cut on the carrying table surface.

15. The cutting method according to claim 13, wherein in the process of cutting the object to be cut, a cutting path runs through part of the openings covered by the object to be cut.

16. The cutting method according to claim 13, further comprising:
driving the pistons to move towards a direction close to the carrying table surface along the sides wall of the openings when actual air pressure data in the openings are less than default air pressure data; and
driving the pistons to move towards a direction away from the carrying table surface along the side walls of the openings when the actual air pressure data in the opening are greater than the default air pressure data.

17. The carrying table according to claim 6, wherein the pistons and the side walls of the openings fit tightly.

18. The carrying table according to claim 8, wherein the plurality of openings are distributed in a matrix.

19. The carrying table according to according to claim 2, further comprising an air pressure sensor, wherein the air pressure sensor is disposed on a side wall of at least one opening and at a position between one piston and the carrying table surface or on one side of the one piston close to the carrying table surface.

20. The carrying table according to claim 19, further comprising a controller,
wherein the controller is configured to receive actual air pressure data detected and sent by the air pressure sensor, compare actual air pressure data with default air pressure data, and hence control a movement direction of the piston.
